(19) United States
(12) Patent Application Publication
(10) Pub. No.: US 2024/0118537 A1
(43) Pub. Date: Apr. 11, 2024

(54) ALL-RESONANT ACTUATION OF PHOTONIC INTEGRATED CIRCUITS

(71) Applicants: The MITRE Corporation, McLean, VA (US); Sandia National Laboratories, Albuquerque, NM (US); MIT - Massachusetts Institute of Technology, Cambridge, MA (US)

(72) Inventors: Mark DONG, Somerville, MA (US); Gerald Neal GILBERT, Princeton, NJ (US); Matthew Scott EICHENFIELD, Albuquerque, NM (US); Dirk Robert ENGLUND, Brookline, MA (US)

(73) Assignees: The MITRE Corporation, McLean, VA (US); Sandia National Laboratories, Albuquerque, NM (US); MIT - Massachusetts Institute of Technology, Cambridge, MA (US)

(21) Appl. No.: 18/480,981

(22) Filed: Oct. 4, 2023

Related U.S. Application Data
(60) Provisional application No. 63/413,470, filed on Oct. 5, 2022.

(51) Int. Cl. G02B 26/10

(52) U.S. Cl. CPC G02B 26/103

(57) ABSTRACT

Provided herein is a photonic integrated circuit and methods for controlling a photonic integrated circuit that can utilize the resonant frequency of one or more components of the photonic integrated circuit to enhance the response of the circuit. At least one component of the photonic integrated circuit can be driven by an electrical signal whose frequency is substantially equal to the mechanical resonance frequency of the component such that the response of the optical component is increased. The component of the photonic integrated circuit can include a phase shifter that can impart a phase shift on a received optical signal. By driving the phase shifter with an electrical signal that is equal to the mechanical resonance frequency of the optical phase shifter, less power can be required to impart a desired phase shift on a received optical signal. The optical components can be implemented using piezoelectric cantilevers.

### CROSS-REFERENCE TO RELATED APPLICATIONS

This application claims the benefit of U.S. Provisional Application No. 63/413,470, filed Oct. 5, 2022, the entire contents of which is incorporated herein by reference.

### FIELD OF THE DISCLOSURE

The present disclosure relates to photonic integrated circuits, and particularly to programmable integrated circuits that are operated using resonant actuation to enhance circuit performance.

### BACKGROUND OF THE DISCLOSURE

Optical phase shifters are opto-electronic devices that impart phase changes upon received optical signals. These devices are commonly used in photonic integrated circuits (PICs) such as those employed in systems such as quantum computing systems and telecommunication systems. For instance, optical phase shifters can be implemented in an optical switch that outputs one or more input signals are to one or more output ports. In such contexts, a phase shift imparted upon the input signals by the phase shifters of the optical switch can determine which output port a particular input signal is switched to.

To cause an optical phase shifter to produce a phase shift in an optical signal that is received by the phase shifter an input, an electrical signal is applied to the optical phase shifter. The amount of phase shift imparted to the input signal may be proportional to or otherwise dependent on this electrical signal. The efficiency of an optical phase shifter can be characterized by the amount of electrical signal required to affect a desired phase shift. By reducing the amount of electrical signal (e.g., the strength of the electrical field) needed to affect a desired phase shift, the overall power consumption of the photonic circuit can be reduced. Thus, employing an optical phase shifter that can efficiently produce desired phase shifts with minimum electrical signal can not only minimize the total power consumption of the PIC, but can also minimize the overall voltage range, device footprint, or optical loss of the PIC. Accordingly, there exists a need for a modulator for controlling the phase and/or amplitude of photonic transmission in a PIC that is power efficient, high-speed, and low-loss.

### SUMMARY OF THE DISCLOSURE

Provided herein is a photonic integrated circuit and methods for controlling a photonic integrated circuit that can utilize the resonance frequency of one or more components of the photonic integrated circuit to enhance the response of the circuit. A component of the photonic integrated circuit can be driven by an electrical signal whose frequency is substantially equal to the mechanical resonance frequency of the component. The mechanical resonance frequency of the component can be adjusted to match a desired frequency.

The component can include a phase shifter that can impart a phase shift on a received optical signal. By driving the phase shifter with an electrical signal that is equal to the mechanical resonance frequency of the optical phase shifter, the amount of power required to impart a desired phase shift on a received optical signal can be reduced. The component may be implemented using a piezoelectric cantilever. The phase shifters, when driven at their mechanical resonance frequency, can be utilized in a variety of contexts including, but not limited to, a 1×N switch, an N×N switch, a phased array, and a phased array that includes mechanical beam steering cantilevers. The frequency at which each phase shifter is driven may be dictated by the frequency requirements of the optical component.

A method for operating a photonic integrated circuit may comprise determining a mechanical eigenfrequency of an optical component of the photonic integrated circuit, generating an electrical signal configured to drive the component of the photonic integrated circuit, matching a frequency of the electrical signal with the determined mechanical eigenfrequency of the component of the photonic integrated circuit, and applying the matched electrical signal to the component of the photonic integrated circuit. Determining a mechanical eigenfrequency of a component of the photonic integrated circuit can involve identifying a frequency requirement of the optical component and adjusting the mechanical eigenfrequency of the optical component to match the identified frequency requirement. Adjusting the eigenfrequency of the optical component to match the identified frequency requirement may comprise adjusting a geometry of the optical component.

The optical component of the photonic integrated circuit may include a piezo-optomechanical cantilever. The piezo-optomechanical cantilever may include a piezoelectric stack comprising one or more materials that are collectively configured to alter a shape of the piezoelectric stack in response to the electrical signal received at the modulator as well as a waveguide deposited on the piezoelectric stack and configured to route the light received by the modulator. The piezoelectric stack can include a first region configured to actuate when the electrical signal is received at the modulator such that a length of the waveguide is altered.

The optical component may be an optical phase shifter. The optical phase shifter may be configured to apply a phase shift to an input signal of the optical phase shifter. The phase shift may be based on the matched electrical signal applied to the optical phase shifter.

One or more optical switches may be included in the photonic integrated circuit. Each optical switch may comprise one or more optical phase shifters, each of which may be driven by an electrical signal. A frequency of the electrical signal applied to each optical phase shifter may be matched to a mechanical eigenfrequency of the optical phase shifter. The optical switches can be configured to form a binary mesh tree.

In some examples, the photonic integrated circuit is configured to receive an input signal and to output the received input signal to a single output of a plurality of outputs at a given time The received input signal may be output to each output of the plurality of output by the photonic integrated circuit in a pre-determined sequence that is based on the frequency of the electrical signals applied to each optical switch of the one or more optical switches. In other examples, photonic integrated circuit is configured to receive a plurality of input signals and to output the received input signals to one or more outputs of the photonic integrated circuit in a predetermined sequence that is based on the frequency of the electrical signals applied to each optical switch of the one or more optical switches.

Various other components may be included in the photonic integrated circuit. For example, the photonic integrated circuit may include a passive optical router, a phased array comprising a plurality of outputs, each of which comprise an optical phase shifter, a Mach-Zehnder interferometer comprising an optical phase shifter, a beam steering cantilever, a phased array comprising a plurality of outputs, each of which comprises a beam steering cantilever, or combinations thereof. The component of the photonic integrated circuit may include an electrode, in which case applying the matched electrical signal to the component of the photonic integrated circuit may comprise applying the matched electrical signal to the electrode of the component.

In addition to the method, a system for operating a photonic integrated circuit is provided. The system may comprise an optical component configured to receive an optical signal, a memory, one or more processors, and one or more programs The one or more programs may be stored in the memory and may be configured to be executed by the one or more processors. When executed by the one or more processors, the one or more programs may cause the processor to determine a mechanical eigenfrequency of the optical component of the photonic integrated circuit, generate an electrical signal configured to drive the component of the photonic integrated circuit, match a frequency of the electric al signal with the determined mechanical eigenfrequency of the component of the photonic integrated circuit, and apply the matched electrical signal to the component of the photonic integrated circuit.

A non-transitory computer readable storage medium storing one or more programs for operating a photonic integrated circuit is also described. The one or more programs may include instructions which, when executed by an electronic device with a display and a user input interface, cause the device to determine a mechanical eigenfrequency of an optical component of the photonic integrated circuit, generate an electrical signal configured to drive the component of the photonic integrated circuit, match a frequency of the electrical signal with the determined mechanical eigenfrequency of the component of the photonic integrated circuit, and apply the matched electrical signal to the component of the photonic integrated circuit.

### BRIEF DESCRIPTION OF THE DRAWINGS

The disclosure will now be described, by way of example only, with reference to the accompanying drawings, in which:

### DISCLOSURE

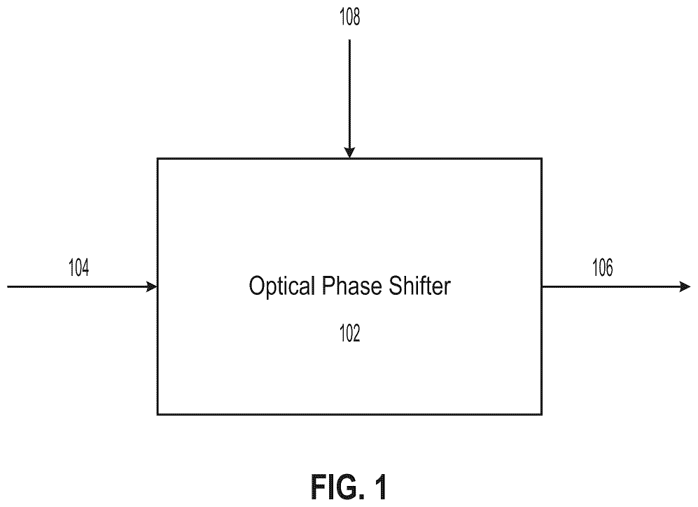

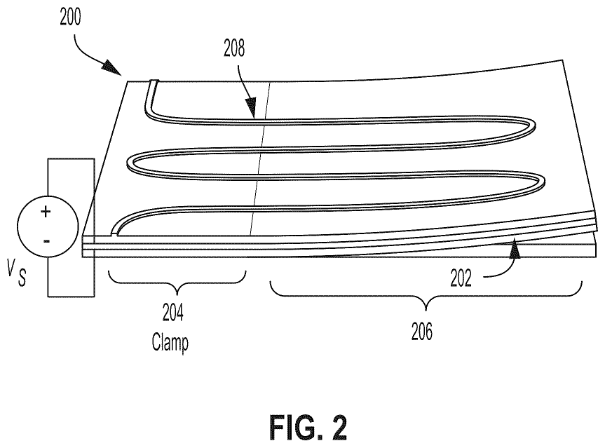

FIG. 1 illustrates an optical phase shifter in accordance with examples of the FIG. 2 illustrates a visible-spectrum phase and amplitude modulator using a piezo-actuated optomechanical cantilever in accordance with one or more examples of the disclosure.

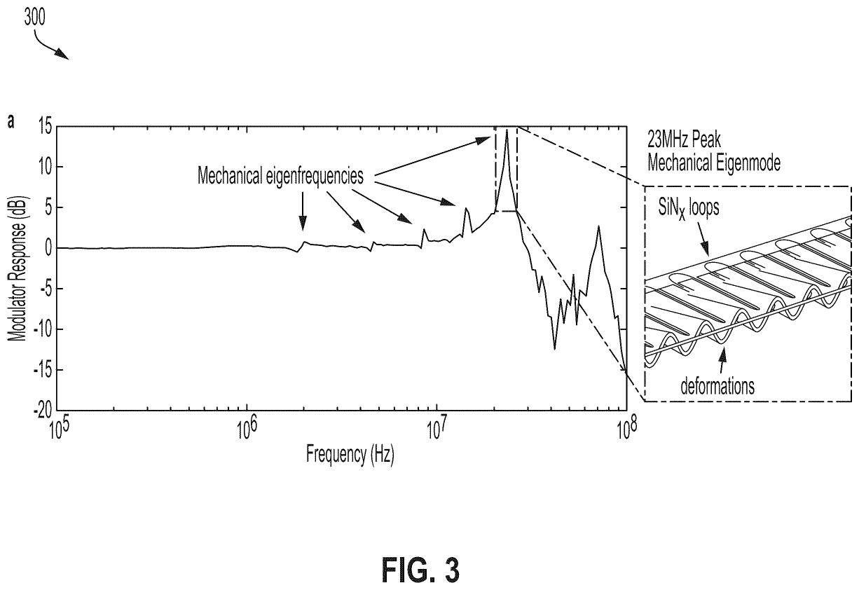

FIG. 3 illustrates a phase response of an optical phase shifter in accordance with one or more examples of the disclosure.

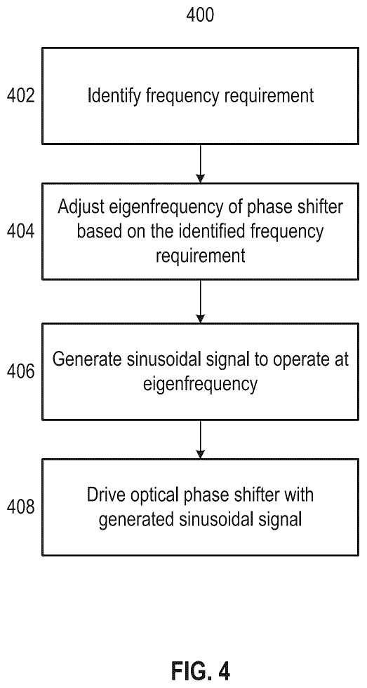

FIG. 4 illustrates a process for tuning an optical phase shifter to operate with a predetermined resonance frequency in accordance with one or more examples of the disclosure.

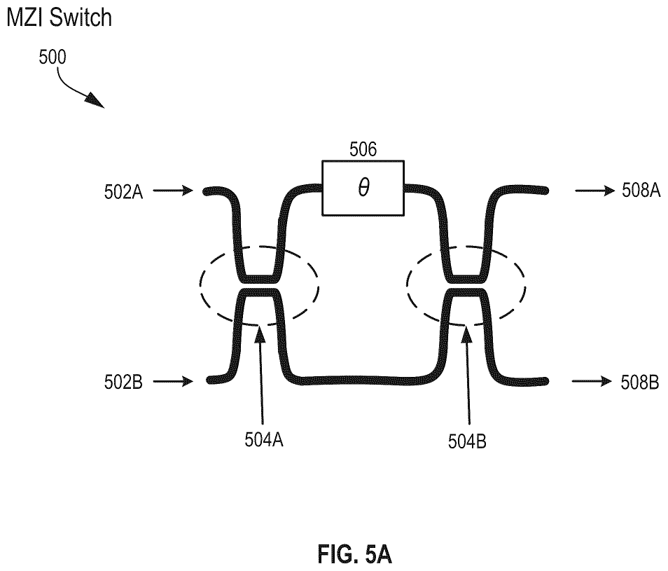

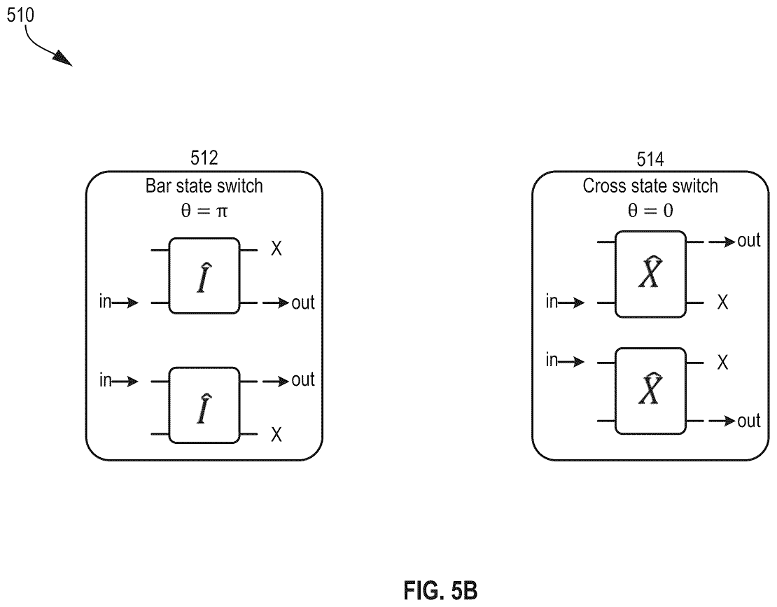

FIG. 5A illustrates an optical switch in accordance with one or more examples of the disclosure.

FIG. 5B illustrates bar and cross states of an optical switch in accordance with one or more examples of the disclosure.

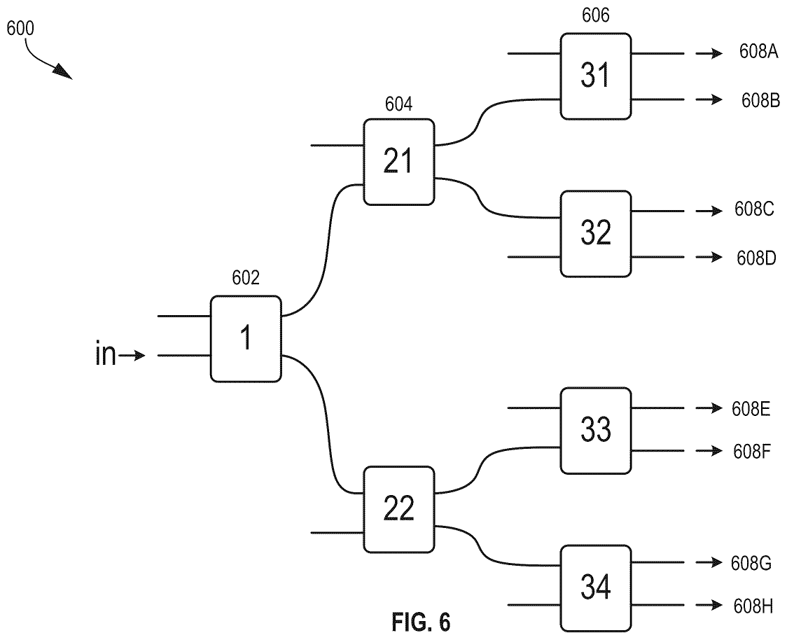

FIG. 6 illustrates a 1×N switch network in accordance with one or more examples of the disclosure.

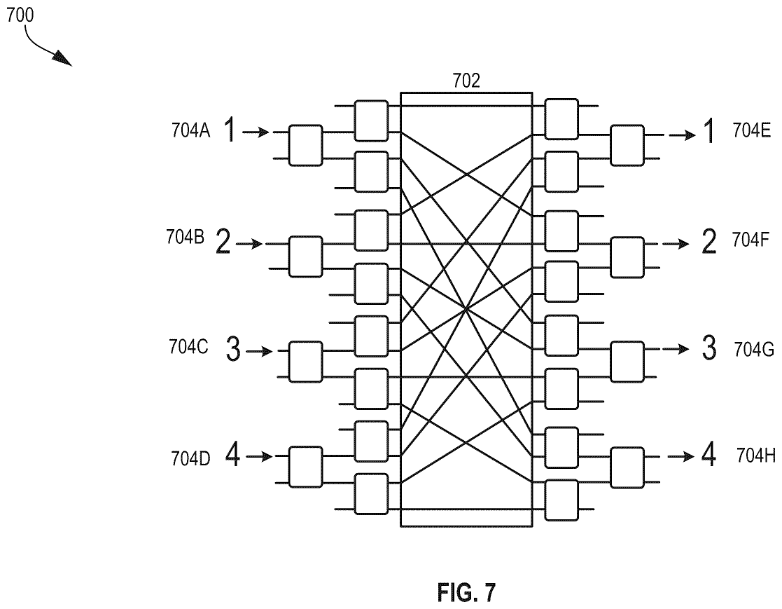

FIG. 7 illustrates a N×N switch network in accordance with one or more examples of the disclosure.

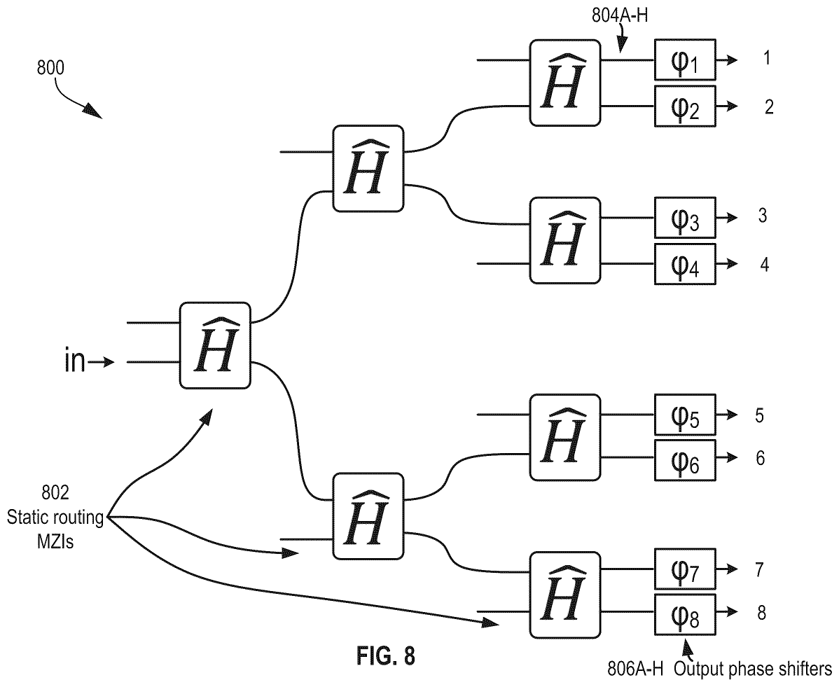

FIG. 8 illustrates a phased array system in accordance with one or more examples of the disclosure.

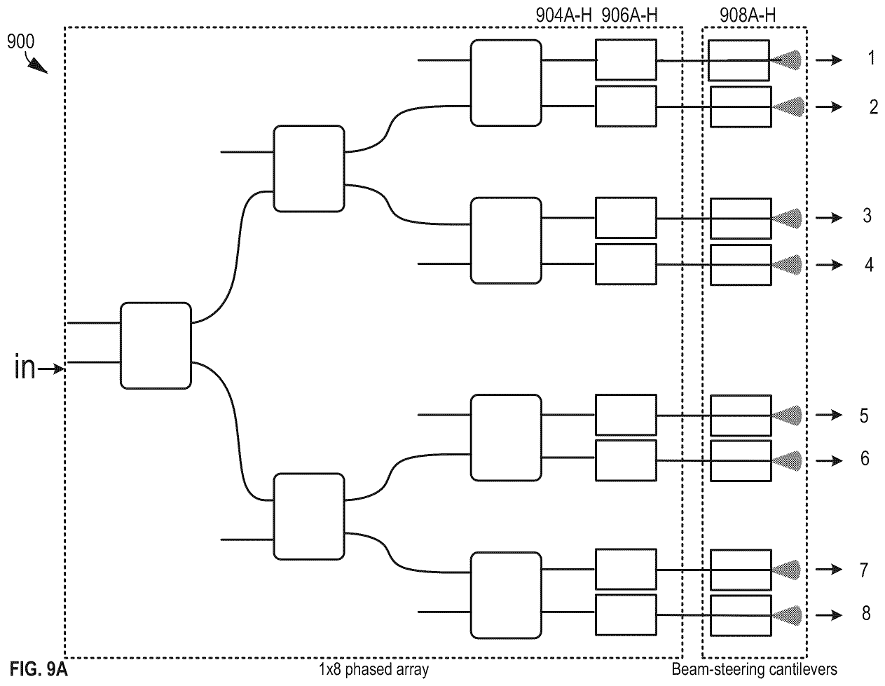

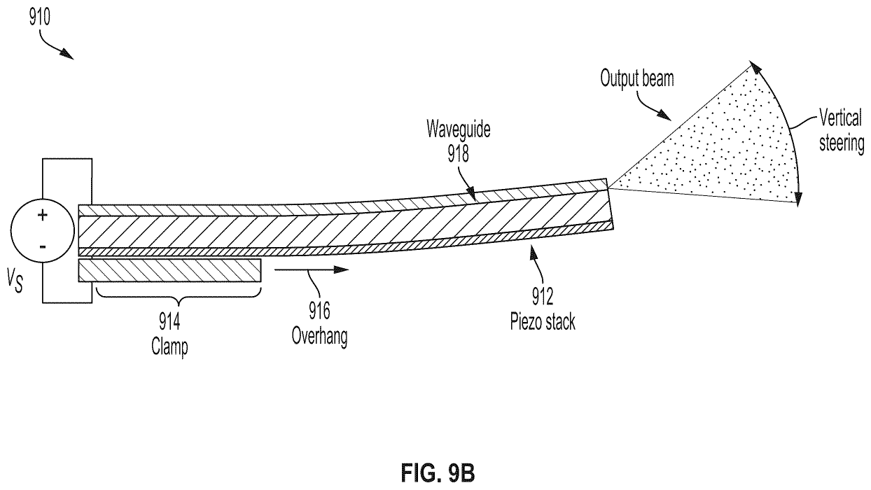

FIG. 9A illustrates a phased array system with beam steering cantilevers in accordance with one or more examples of the disclosure.

FIG. 9B illustrates a beam steering cantilever according to examples of the disclosure.

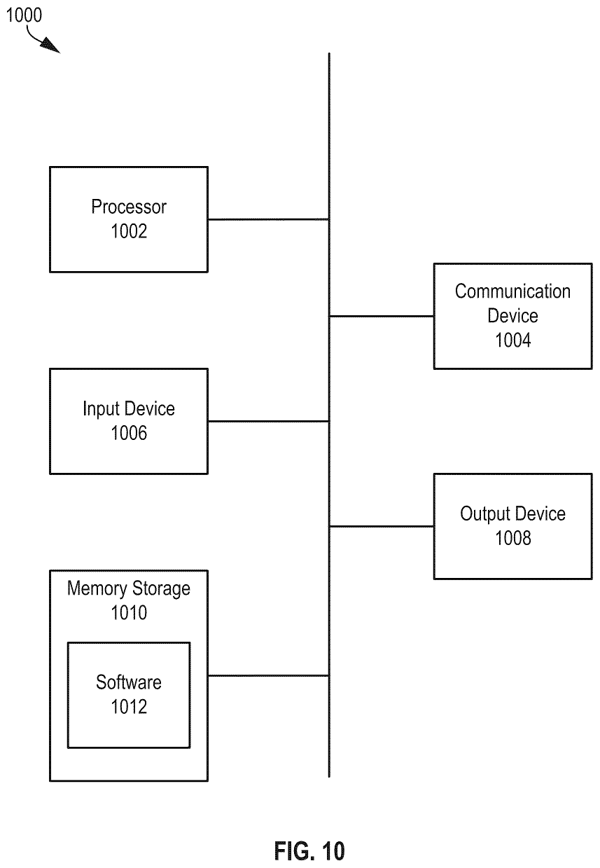

FIG. 10 illustrates a computing device in accordance with one or more examples of the disclosure.

### DETAILED DESCRIPTION OF THE DISCLOSURE

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The required structure for a variety of these systems will appear from the description below. In addition, the present disclosure is not described with reference to any particular programming language. It will be appreciated that a variety of programming languages may be used to implement the teachings of the present disclosure as described herein.

Photonic integrated circuits (PIC) commonly employ phase shifters to alter the phase of a light beam that is being transmitted by the circuit. An optical phase shifter alters the phase of a light source by inducing a change in the effective refractive index of the transmission medium used to carry the light through the circuit. An optical phase shifter can induce the change in the effective refractive index by applying an electrical signal to the transmission medium (such as silicon).

FIG. 1 illustrates an exemplary optical phase shifter according to examples of the disclosure. The photonic integrated circuit 100 of FIG. 1 can include an optical phase shifter 102 that takes a light source at its input 104 (transported using a waveguide) and produces an output signal 106 whose phase is shifted with respect to the input signal 104. The phase shift is caused by an electrical signal that is applied to the phase shifter 102 at input 108. The amount of phase shift applied to the input signal 104 can be based on and proportional to the amount of the electrical signal (e.g., the amount of current, voltage, and/or power of the electrical signal) applied to the optical phase shifter 102 at input 108. Thus, in one or more examples, in order to increase the amount of phase shift imparted to an optical signal received at input 104, the amount of electrical signal applied to the phase shifter is increased.

The phase shifter 102 can be implemented using a piezo-actuated optomechanical cantilever. As will be discussed in further detail, certain properties of an optomechanical cantilever based optical phase shifter can be harnessed to create PICs that are efficient from a power consumption/spatial footprint standpoint.

FIG. 2 illustrates an exemplary visible-spectrum phase and amplitude modulator using a piezo-actuated optomechanical cantilever in accordance with one or more examples of the disclosure. The modulator 200 can be used to implement various components found in a PIC. More specifically, the modulator 200 can be used as a phase shifter in the manner described above with respect to FIG. 1.

The modulator 200 can be used as part of a single chip solution including a small number of electronic inputs that control a large number of complex circuits. The modulator 200 can also be used as a component in optogenetics and display technologies, optical switches and optical neural networks, phased arrays and light ranging applications, or a quantum network switch. As will be discussed further, the modulator 200 can be implemented as a singly clamped cantilever with large released regions (in excess of 500 μm), low voltage loss product (“VLP”) (between 20-30 V-dB), low-hold power consumption (less than 30 nW), and minimal modulation losses.

The modulator 200 can include a piezo stack 202 that is clamped via a clamp 204 such that the piezo stack 202 has an overhang 206 that extends perpendicularly from the clamp 204. The piezo stack 202 can be configured as a cantilever, that is fixed (i.e., firmly attached) at the clamp 204 and is not fixed or attached in any manner across the overhang 206. The overhang 206 can be defined as an area of the piezo stack 200 that can mechanically deform because it extends outwardly from a fixed point and is not otherwise supported by any structural element. On overhang 206, the modulator 200 can have a single-mode silicon waveguide 208 that can extend across the piezo stack 202 in a looped arrangement. The piezo stack can include a stack of aluminum, aluminum nitride, and aluminum layers, which form the electrodes and piezo layers that can be optomechanically actuated by the application of an electrical signal to the stack.

Voltage (Vs) can be applied to the modulator 200 across the piezo stack 202, which can impart a path-length change to the integrated waveguide 208 that induces an effective phase shift (by changing the effective refractive index.) Before applying voltage, the waveguide 208 can have an un-stretched length (L), and as voltage is applied to the modulator 200, the piezo stack 202 can experience mechanical deformation that lengthens the path of the waveguide 208 by a stretched length (ΔL), which induces the phase shift. As discussed above, the voltage required to impart a phase shift on photons as they pass through the waveguide 208 can be proportional to the amount of phase shift. Thus, the larger the desired phase shift, the larger the voltage needed to induce the desired phase shift.

The physical mechanisms that contribute to the optical phase shift can be caused by waveguide path length deformations (ΔL) induced by applying voltage (and/or another type of electrical signal) across the piezo layer, as well as by stress-optics effects. Increasing the number of waveguide loops can increase the stretched length ΔL of the waveguide 508, thereby increasing the phase shifter response of the modulator 500. Based on experimental data, it was determined that the ΔL scales approximately linearly with cantilever overhang (e.g., the length of the cantilever) and the number of waveguide loops.

The piezo stack 202 can have natural resonant frequencies. Because mechanical structures tend to deform at certain natural resonant frequencies (e.g., at eigenfrequencies corresponding to eigenmodes), and the resonant frequencies tend to differ based on the length of the system, the overhang length of the modulator 200 can be engineered based on the natural resonant frequencies of the system. Accordingly, the mechanical resonance frequency of the piezo stack 202 can be harnessed to enhance the phase shift per volt applied to the modulator 200 (discussed in further detail below). The geometry of the piezo stack 202 can be designed to have a resonance frequency at desired intervals. Based on experimental data, it was determined that the number of waveguide loops does not impact, or marginally impacts, the peak mechanical frequency of the piezo stack 202. Instead, the resonance mode deformations are predominantly affected by the density of loops. Thus, the density of the loops can be an important design factor when determining the overhang length of the modulator 200, with the number of loops being an important design consideration regarding the total phase shift induced by the modulator 200.

A shorter cantilever (with a shorter overhang length) may induce a smaller phase shift response relative to a longer cantilever. Although longer cantilevers are capable of inducing a larger phase shift due to the natural resonance frequency of a longer cantilever being relatively small (measured in MHz), a longer cantilever cannot be operated as quickly because of its lower resonance frequency.

The mechanical resonance frequency can be used to enhance the phase response per volt applied to the modulator. Accordingly, engineering the cantilever geometry presents design considerations, which can be used to engineer the appropriate geometric constraints for a given modulator. Such design considerations can include device size, operating voltage, operating losses, and mechanical resonance frequency. Particularly because the cantilever length impacts mechanical resonance frequency and thus the speed at which the cantilever can be operated, it is important to design the cantilever appropriately. Example cantilever geometries designed and determined via experimental analysis are found below in Table 1.

TABLE 1
Characteristics of Piezo-Optomechanical Cantilevers

| | Overhang | Number of | Peak resonant | | |
|---|---|---|---|---|---|
| | length | Waveguide | frequency | Footprint | VLP |
| | (μm) | loops | (MHz) | (μm²) | (V-dB) |
| Canti- | 300 | 6 | 6.8 | 350 × 325 | 22 |
| lever 1 | | | | | |
| Canti- | 80 | 19 | 23.3 | 100 × 650 | 36 |
| lever 2 | | | | | |

The cantilever geometries exhibited in Table 1 were designed and determined via experimental analysis in order to determine the effect of overhang length and number of waveguide loops, on peak resonant frequency and VLP in order to determine optimal geometries for the application of DC and AC current. As demonstrated in Table 1, Cantilever 1 has a longer overhang length and only six waveguide loops and exhibits a low peak resonant frequency and relatively lower voltage-loss product. Accordingly, because Cantilever 1 has a low peak resonant frequency, the design of Cantilever 1 is optimized for slower switching and operating using DC. In contrast, Cantilever 2 has a shorter overhang length and greater number of waveguide loops as well as a much higher peak resonant frequency. The design of Cantilever 2 thus has been optimized for fast switching and operating using AC.

FIG. 3 illustrates an exemplary modulator response of an optical phase shifter in accordance with one or more examples of the disclosure. The response 300 of FIG. 3 illustrates the response of the modulator (y-axis, specified in dB) when a sinusoidal electrical signal of varying frequency (x-axis, specified in Hz) is applied to the modulator. As illustrated in FIG. 3, the response contains one or more isolated peaks (referred to as mechanical eigenfrequencies), wherein the modulator response is heightened when an electrical sinusoidal signal of a particular frequency is applied to the modulator. When the frequency of the electrical signal applied to cause the phase shift (as described above) matches one of the mechanical eigenfrequencies of the modulator, the modulator produces a heightened response. A heightened response can include producing a larger phase shift in an input optical signal versus when an electrical signal (of the same amplitude) at a non-eigenfrequency is applied to the modulator. In one or more examples, the enhancement can be on the order of a mechanical quality factor Qm which can amount to many orders of magnitude improvement. The improvement can mean that for a given PIC, less voltage is needed to affect a desired phase shift and thus, the PIC's overall power consumption and/or device footprint (which can be made compact due to lower power consumption) is reduced.

The mechanical resonances of the modulator can be selected by altering the geometry of the piezoelectric stack so as to change the mechanical resonant frequencies (i.e., the mechanical eigenfrequencies) of the overall modulator. The mechanical eigenfrequencies of a particular modulator can be engineered by changing the cantilever geometry. Thus, if a particular application of a PIC requires a phase shift to occur at a specific frequency, then the cantilever geometry of the piezoelectric stack described above with respect to FIG. 3 can be modified so as to match the desired frequency of the phase shift. In this way, the modulator can be matched to a desired phase shift frequency such that when an electrical signal with the desired frequency is applied to the modulator, the modulator exhibits an enhanced response such that less power is needed to produce the desired phase shift versus using a modulator whose mechanical eigenfrequencies are not matched to the desired frequency of the phase shift.

FIG. 4 illustrates an exemplary process for tuning an optical phase shifter to operate with a predetermined resonance frequency in accordance with one or more examples of the disclosure. The process 400 of FIG. 4 can be used to calibrate an optical phase shifter/modulator to modulate the phase of an incoming optical signal at a desired frequency while also matching the phase shifter's mechanical resonant frequency to the desired frequency of the phase shift so as to realize the enhanced performance associated with modulating the signal that the resonant frequency as described above. The process 400 can begin at step 402 wherein a specific frequency requirement for the optical phase shifter is identified.

As described in further detail below, a phase shifter that changes modulates the phase of an incoming optical signal can have a variety of uses and applications. For instance, a periodic phase shifter can be employed in a quantum computing context to enable optomechanical switching networks for large-scale entanglement of atomic memories. Operating the phase shifter at the resonant frequency can greatly simplify the quantum computing architecture that requires periodic switching. A periodic phase shifter can be used in quantum networks to enable large-scale switches from one optical mode (such as fiber within an optical fiber network) to N qubits by repetitive scanning across N color centers within an array. This multiplexed quantum memory access can increase entanglement rate between quantum repeaters by a factor N and/or reduce decoherence-induced memory errors.

A periodic phase shifter can also be used to implement a phased array LIDAR. In particular, a periodic phase shifter can be used to enable high-speed and simple-to-operate photonic chips to be embedded in many systems requiring cyclical scanning capabilities. Examples of LIDAR systems requiring cyclical scanning capabilities include optical meteorology, land surveying, autonomous driving, etc.

In addition, a periodic phase shifter can be used to implement an imager/display. As discussed above, since the power saving associated with operating at the mechanical resonant frequency can engender an overall reduced size footprint for the PIC, operating the phase shifter at the resonant frequency can open the door for commercial and space constrained applications like augmented/virtual reality, hand-held 3D imaging etc.

Numerous other uses and applications of periodic phase shifters are possible. For instance, in addition to the described examples, a periodic phase shifter can be used to implement an optical accelerator that enables repetitive optical memory access as desired in output stationary optical networks.

The frequency of the phase shift needed for a particular application can vary depending on the application, and thus in one or more examples, step 402 can include determining what the desired frequency is based on the application that the PIC will be used for. Once the frequency requirement has been identified at step 402, the process 400 can move to step 404 wherein the mechanical eigenfrequency of the optical phase shifter can be adjusted/set to match the frequency requirement identified at step 402. Adjusting the mechanical eigenfrequency of a modulator and, in particular, a piezo-optomechanical cantilever such as the one described above with respect to FIG. 2, can include changing the cantilever geometry. Adjusting the cantilever geometry can include adjusting the cantilever overhang, adjusting the number of waveguide loops, and adjusting the mass of the cantilever by selectively etching away the insulating material (silicon dioxide) of the cantilever. The resonance frequency of the modulator can be determined by applying an electrical signal to the modulator and sweeping the frequency of the signal to determine the modulator response, similar to the response 300 of FIG. 3. One of the eigenfrequencies identified in the modulator response should match the frequency of the electrical signal determined at step 402. Once the eigenfrequency of the modulator has been set at step 404, the process 400 can move to step 406, wherein a sinusoidal electrical signal with a frequency that matches the frequency identified at step 402 can be generated. After the signal has been generated at step 406, the process 400 can move to step 408 wherein the signal is applied to the optical phase shifter (i.e., modulator).

Adjusting the mechanical eigenfrequency of a modulator can also include utilizing one or more driving techniques on a single cantilever with a set resonance co. Higher harmonics (ω*2\hat{ }N) can be synthesized on-chip using a common excitation co together with cascaded second harmonic generation. For example, by driving the cantilever on resonance with a signal amplitude of twice the Vpi, the modulator response can acquire a frequency at the second harmonic 2*ω of the fundamental mechanical resonance. A nonlinear response can be created in the cantilever by fabricating the cantilever to have a maximum deflection before it contacts a mechanical limiter (such as the substrate), resulting in anharmonic oscillation and frequency mixing of the driving sinusoidal signals.

As discussed above, an optical phase shifter can that is driven by a periodic sinusoidal electrical signal (thereby inducing a periodic phase shift) at a given frequency can be used in a variety of PIC circuits designed for a variety of applications. An optical phase shifter driven at its resonant frequency can be used to implement an optical switch that takes an input and switches the input to a plurality of outputs in a periodic manner as described in further detail below. FIG. 5A illustrates an exemplary optical switch in accordance with one or more examples of the disclosure. The switch 500 of FIG. 5A can be implemented as a Mach-Zehnder Interferometer (MZI) switch. The MZI switch 500 can include two inputs 502A and 502B. Either input 502A or 502B can be utilized to receive an input optical signal while the not utilized input can be terminated so as to not receive a signal. The MZI switch 500 can include two separate outputs 508A and 508B. The MZI switch input signal (either 502A or 502B) can be switched to be either output at 508A or 508B depending on the phase shift imparted by a phase shifter 506 of the MZI switch 500. The MZI switch 500 can include 50:50 couplers 504A and 504B, which can be used to split and couple the input signals 502A and 502B.

The MZI switch 500 can operate in a “bar state” in which the switch is configured to switch the input signal to be outputted on the output of the switch that is on the same side as the input. For example, if the switch 500 of FIG. 5A were to operate in a bar state and input 502A was the input in which a signal was received, then the signal received at 502A would be outputted to output 508A of MZI switch 500. Similarly, if 502B were the input of MZI switch 500, then if the MZI switch 500 were operating in the bar state, then the signal received at 502B would be outputted to output 508B. The MZI switch 500 can operate in a cross state” in which the switch in configured to switch the input signal to be outputted on the output of the switch that is on the opposite side as the input. For example, if the switch 500 of FIG. 5A were to operate in a cross state and input 502A was the input in which a signal was received, then the signal received at 502A would be outputted to output 508B of MZI switch 500. Similarly, if 502B were the input of MZI switch 500, then if the MZI switch 500 were operating in the cross state, then the signal received at 502B would be outputted to output 508A.

Control over whether the MZI switch 500 is operating in the bar state or the cross state can depend on the phase shift created by phase shifter 506. Thus, control over switch 500 can be achieved by applying an electrical signal to the phase shifter 506. FIG. 5B illustrates exemplary bar and cross states of an optical switch in accordance with one or more examples of the disclosure. Illustration 510 demonstrates the phase that can be required to operate the switch in a particular state, and also demonstrates the input/output implicated when the device is operating in a particular state. For instance, in order to cause the switch to operate in the bar state as indicated at 512, a phase shift of π radians (i.e., 180°) can be applied by the phase shifter of the MZI switch. Once the phase shifter imparts π radians of phase shift to its input signal, the MZI switch will cause the input signals to switch to the same side output as indicated at 512. In order to cause the switch to operate in the cross state as indicated at 514, a phase shift of 0 radians (i.e., 0°) can be applied by the phase shifter of the MZI switch. Once the phase shifter imparts 0 radians of phase shift to its input signal, the MZI switch will cause the input signals to switch to the opposite side output as indicated at 514.

Returning to the example of FIG. 5A, when a periodic electrical signal is applied to the phase shifter 506 of MZI switch 500, the phase shifter 506 will vacillate between 0 and π radians at a selected frequency (chosen to match the mechanical eigenfrequency of the MZI switch). Thus, the MZI switch 500 can cycle between being in the bar state and the cross state at a frequency that matches the frequency of the electrical signal applied to phase shifter 506. This can mean that, regardless of whether the input signal is applied to input 502A or input 502B, the MZI switch 500 will switch the output to 508A and 508B in a periodic manner with the switching frequency being equal to the frequency of the electrical signal being applied to phase shifter 506. Thus, the MZI switch 500 can be referred to as a programmable switch insofar as the switching frequency (i.e., the frequency at which the output of the switch changes) can be programmed by changing the frequency of the electrical signal being applied to the phase shifter of the switch. Furthermore, since the MZI switch 500 is being driven by an electrical signal that matches its mechanical resonance frequency (i.e., mechanical eigenfrequency), the amount of power required to drive the switch is less than if driven to another non-resonant frequency due to the heightened response of the modulator to an electrical signal when driven at the mechanical resonant frequency.

A MZI switch such as MZI switch 500 of FIG. 5 (when driven at the resonant frequency of the modulator) can be used in a variety of contexts that require a switch to switch between its outputs at a periodic interval. As an example, the MZI switch 500 of FIG. 5 can be utilized in any interconnected MZI mesh that forms a large-scale photonic network. For instance, and as described below, an all resonantly driven interconnected MZI mesh can be used to implement a binary tree mesh that can be utilized to switch a single input between multiple output ports at a periodic interval.

FIG. 6 illustrates an exemplary 1×N switch network in accordance with one or more examples of the disclosure. The 1×N switch network 600 can be implemented as a binary tree mesh in which a plurality of MZI switches are each operated at their respective resonant frequencies. The switch network 600 can be characterized as having tiered layers of MZI switches. The switch network 600 can include a first tier 602 that includes a single switch (labeled as “1” in the figure.) The single switch of the first tier 602 can be configured to receive the input signal from a source. The two output signals of the first tier switch 602 can be each routed to a separate MZI switch that forms a second tier of switches 604 of the MZI switch network 600. The second switches can include two switches (labeled “21” and “22” in the figure) with each switch of the second tier configured to receive an output from the switch of the first tier 602.

The switch network 602 can be implemented as a binary tree mesh in which eat output of a given tier is fed as an input to its own respective MZI switch. Thus, each output of switch “21” and “22” of tier 604 can be fed to the input of a switch in the third tier of the network 606. For instance, a first output of switch 21 can be inputted to switch 31 of third tier 606. The second output of switch 21 can be output to switch 32 of tier 606. The first output of switch 22 can be routed to an input of switch 33 of tier 606, and the other output of switch 22 can be routed to an input of switch 34 of tier 606. Since each switch has two outputs, and each output is routed to its own switch, each tier of the network can include 2N−1 switches, where N is equal to the tier number of the switch network. Thus, the first tier will have a single switch, the second tier will have two switches, the third tier will have four switches, and so on and so forth. In the example of switch network 600 of FIG. 6, there are three total layers (602, 604, and 606) provided for the purposes of illustration, however the disclosure should not be seen as limiting.

The switch network 600 of FIG. 6 can be configured to output one of the eight output channels 608A-H at any given time, in an order determined by the phase offsets of the switching signals (i.e., electrical signals) applied to each of the individual switches in the network. The switching process will repeat as long as the electrical drive signals are running. Since each switch in the switching network 600 is being driven by a periodic electrical signal whose frequency matches that of the mechanical resonant frequency of the switch, less power and voltage is required to drive each of the switches, meaning that the power consumption of the switching network 600 as a whole can be less than if the switches were not being driven at their mechanical eigenfrequencies. In this way, the switching network 600 is not only programmable insofar as the order and frequency at which the outputs are activated can be programmed by the electrical signals applied to each switch but is also operating with minimal power consumption.

The MZI switch described above with respect to FIGS. 5A and 5B can also be applied to other types of PICs. For instance, the MZI switch that is driven all-resonantly can be used to implement more complex meshes than the one described above with respect to FIG. 6. FIG. 7 illustrates an exemplary N×N switch network in accordance with one or more examples of the disclosure. The switch matrix 700 of FIG. 7 can be implemented by combining separated binary trees with an N×N passive optical routing component 702. The passive optical routing component 702 can be implemented using spliced fibers, optical interposers in silica, or using free-spacing imaging, as examples. The passive optical routing component 702 can be implemented as described above to form a non-blocking N×N matrix switch.

The switch matrix of 700 can include a plurality of 1×N binary switches similar to the switching network 600 described above with respect to FIG. 6. For instance, in the example of switch matrix 700 of FIG. 7, the switch matrix can include eight 1×2 switching networks 704A-H. Switching networks 704A-D can be utilized to receive the inputs to the switch matrix 700 (i.e., 4 inputs), while switching networks 704E-H can be utilized to provide the outputs of the switch matrix. Each of the switches of each switching network can be driven resonantly as described above so as periodically cycle the inputs to one or more of the outputs of the switch matrix 700. The switch matrix 700 of FIG. 7 can utilize eight 1×2 switch networks 704A-H and a 16×16 passive router 702 to create a 4×4 switch matrix in which the four inputs are cycle to the four outputs in a periodic manner based on the frequencies and phases of the electrical signals applied to each of the switches forming each switch network.

The switch described above with respect to FIGS. 5A-B can also be utilized in a phased array system for use in such applications as range finding, self-driving vehicles, 3D imaging in mobile devices, etc. FIG. 8 illustrates an exemplary phased array system in accordance with one or more examples of the disclosure. The circuit 800 includes a static routing binary tree 802 that is configured to distribute optical power to the output put channels 804A-H. Each output channel 804A-H can be connected to its own resonantly-drive phase shifter 806A-H at a specific frequency ωₒ+ηΔω, where ωₒ can represent a base frequency in the 10 MHz-40 MHz range and Δω<<ω can be a small frequency offset that can determine the rate at which the relative output channel phases change over time. This may allow the phased array to sweep the full 180-degree half-circle on the time scale of 2π/Δω and repeating as long as the circuit is being operated. The circuit 800 can operate by distributing the input light (labeled as “in” in the figure) through the static binary tree 802 to all output channels 1-8. Each output channel includes an output phase shifter (804A-H) which imparts a phase shift ϕₙ. The electrical signals used to drive each of the output phase shifters 804A-H can be specifically tailored to cause the array to sweep the phase differences between the output channels in order to steer the output beam. For instance, the signals can be specifically tailored to cause the beam formed by the individual output channels to periodically sweep the field of view.

In addition to being used to implement a phased array system, an all-resonantly driven PIC can also be utilized to implement a phased array system with beam steering cantilevers. FIG. 9A illustrates an exemplary phased array system with beam steering cantilevers in accordance with one or more examples of the disclosure. In one or more examples, the system 900 of FIG. 9A can be substantially similar to the system 800 described above with respect to FIG. 8 except that the system 800 can include one or more beam steering cantilevers 908A-H. Thus, the static routing binary tree 902, the output channels 904A-H and the phase shifters 906A-H can operate in substantially the same manner described above with respect to their counterparts in system 800.

As described above, the system 900 of FIG. 9A can also include a plurality of beam steering cantilevers 908A-H. The beam steering cantilevers can be configured to steer the output beam produced at each cantilever 908A-H in a particular direction based on a voltage applied to a piezo stack that is part of the cantilever (described in detail below). Thus, in addition to steering a beam using a phased array using a system such system 800 described above with respect to FIG. 8, each of the individual beams produced by the phased array can also be mechanically steered using a mechanical cantilever that is controlled by an electrical signal which determines the direction in which the beam is pointed. The mechanical cantilever can be configured to steer the beam in response to an electrical signal, with the direction being dictated by the voltage of the electrical signal being applied to it.

FIG. 9B illustrates an exemplary beam steering cantilever according to examples of the disclosure. The beam steering cantilever 910 can include a piezo stack 912 that is clamped via a clamp 914 such that the piezo stack 912 has an overhang 916 that extends perpendicularly from the clamp 914. The piezo stack 912 can be configured as a cantilever, that is fixed (i.e., firmly attached) at the clamp 914 and is not fixed or attached in any manner across the overhang 916. The overhang 916 can be defined as an area of the piezo stack 910 that can mechanically deform because it extends outwardly from a fixed point and is not otherwise supported by any structural element. On overhang 916, the modulator 910 can have a single-mode silicon waveguide 918 that can extend across the piezo stack 912. The piezo stack 912 can include a stack of aluminum, aluminum nitride, and aluminum layers, which form the electrodes and piezo layers that can be optomechanically actuated by the application of an electrical signal 920 to the stack such as by voltage Vs as illustrated in the figure.

When an electrical signal is applied to the piezo stack 912, it can cause the stack 912 to mechanically actuate. The degree to which the piezo stack 912 actuates can be based on the amount of voltage applied to the piezo stack. If a sinusoidal or periodic electrical signal is applied to the piezo stack 912, then in one or more examples, the output beam output by the cantilever 910 can move up and down in a vertical direction (as indicated on the figure) in a periodic manner.

Returning to the example of FIG. 9A, the beam steering cantilevers 908A-H can be driven by periodic signals whose frequency are matched to the mechanical resonant frequency of the beam steering cantilevers thereby causing the beam steering cantilevers to move in a direction perpendicular to the piezo electric stack used to implement the cantilever, while also requiring less power consumption due to the all-resonant operation of the beam steering cantilevers. The beam steering cantilevers 908A-H can allow for the phased array to sweep the beam in three dimensions. The output phase shifters can sweep the beam in the plane of the chip (i.e., a 2D sweep) while the beam steering cantilevers 908A-H can allow for the beam to be swept orthogonally to the plane of the chip thus producing a three-dimensional sweep of the beam.

FIG. 10 illustrates an exemplary computing device 1000, in accordance with one or more examples of the disclosure. Device 1000 can be a host computer connected to a network. Device 1000 can be a client computer or a server. As shown in FIG. 10, device 1000 can be any suitable type of microprocessor-based device, such as a personal computer, workstation, server, or handheld computing device (portable electronic device) such as a phone or tablet. The device can include, for example, one or more of processors 1002, input device 1006, output device 1008, storage 1010, and communication device 1004. Input device 1006 and output device 1008 can generally correspond to those described above and can either be connectable or integrated with the computer.

Input device 1006 can be any suitable device that provides input, such as a touch screen, keyboard or keypad, mouse, or voice-recognition device. Output device 1008 can be any suitable device that provides output, such as a touch screen, haptics device, or speaker.

Storage 1010 can be any suitable device that provides storage, such as an electrical, magnetic, or optical memory, including a RAM, cache, hard drive, or removable storage disk. Communication device 1004 can include any suitable device capable of transmitting and receiving signals over a network, such as a network interface chip or device. The components of the computer can be connected in any suitable manner, such as via a physical bus or wirelessly.

Software 1012, which can be stored in storage 1010 and executed by processor 1002, can include, for example, the programming that embodies the functionality of the present disclosure (e.g., as embodied in the devices as described above).

Software 1012 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 1010, that can contain or store programming for use by or in connection with an instruction execution system, apparatus, or device.

Software 1012 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Device 1000 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 1000 can implement any operating system suitable for operating on the network. Software 1012 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A method for operating a photonic integrated circuit comprising:
determining a mechanical eigenfrequency of a component of the photonic integrated circuit;
generating an electrical signal, wherein the electrical signal is configured drive the component of the photonic integrated circuit;
matching a frequency of the electrical signal with the determined mechanical eigenfrequency of the component of the photonic integrated circuit; and
applying the matched electrical signal to the component of the photonic integrated circuit.

2. The method of claim 1, wherein determining a mechanical eigenfrequency of a component of the photonic integrated circuit comprises:
identifying a frequency requirement of the optical component; and
adjusting the mechanical eigenfrequency of the optical component to match the identified frequency requirement.

3. The method of claim 2, wherein adjusting the eigenfrequency of the optical component to match the identified frequency requirement comprises adjusting a geometry of the optical component.

4. The method of claim 1, wherein the optical component comprises a piezo-optomechanical cantilever, and wherein the piezo-optomechanical cantilever comprises:
a piezoelectric stack, wherein the piezoelectric stack comprises one or more materials that are collectively configured to alter a shape of the piezoelectric stack in response to the electrical signal received at the modulator;
a waveguide deposited on the piezoelectric stack, wherein the waveguide is configured to route the light received by the modulator; and
wherein the piezoelectric stack includes a first region, wherein the first region is configured to actuate when the electrical signal is received at the modulator such that a length of the waveguide is altered.

5. The method of claim 1, wherein the component is an optical phase shifter, wherein the optical phase shifter is configured to apply a phase shift to an input signal of the optical phase shifter, and wherein the phase shift is based on the matched electrical signal applied to the optical phase shifter.

6. The method of claim 5, wherein the photonic integrated circuit comprises one or more optical switches, wherein each optical switch comprises one or more optical phase shifters, and wherein each optical phase shifter of the one or more optical phase shifters is driven by an electrical signal, and wherein a frequency of the electrical signal applied to each optical phase shifter is matched to a mechanical eigenfrequency of the optical phase shifter.

7. The method of claim 6, wherein the one or more optical switches are configured to form a binary mesh tree.

8. The method of claim 6, wherein the photonic integrated circuit is configured to receive an input signal, and output the received input signal to a single output of a plurality of outputs at a given time, wherein the photonic integrated circuit is configured to output the received input signal to each output of the plurality of output in a pre-determined sequence, and wherein the pre-determined sequence is based on the frequency of the electrical signals applied to each optical switch of the one or more optical switches.

9. The method of claim 6, wherein the photonic integrated circuit is configured to receive a plurality of input signals, and output the received input signals to one or more outputs of the photonic integrated circuit in a predetermined sequence, and wherein the pre-determined sequence is based on the frequency of the electrical signals applied to each optical switch of the one or more optical switches.

10. The method of claim 9, wherein the photonic integrated circuit comprises a passive optical router.

11. The method of claim 5, wherein the photonic integrated circuit comprises a phased array, wherein the phased array comprises a plurality of outputs, and wherein each output of the plurality of outputs comprises an optical phase shifter.\

12. The method of claim 5, wherein the photonic integrated circuit comprises a Mach Zehnder interferometer, and wherein the Mach Zehnder interferometer comprises the optical phase shifter.

13. The method of claim 1, wherein the component of the photonic integrated circuit comprises a beam steering cantilever.

14. The method of claim 13, wherein the photonic integrated circuit comprises a phased array, wherein the phased array comprises a plurality of outputs, and wherein each output of the plurality of outputs comprises a beam steering cantilever.

15. The method of claim 1, wherein the component comprises an electrode, and wherein applying the matched electrical signal to the component of the photonic integrated circuit comprises applying the matched electrical signal to the electrode of the component.

16. A system for operating a photonic integrated circuit comprising:
an optical component, wherein the optical component is configured to receive an optical signal;
a memory;
one or more processors; and
one or more programs, wherein the one or more programs are stored in the memory and configured to be executed by the one or more processors, the one or more programs when executed by the one or more processors cause the processor to:
determine a mechanical eigenfrequency of the component of the photonic integrated circuit;
generate an electrical signal, wherein the electrical signal is configured drive the component of the photonic integrated circuit;
match a frequency of the electrical signal with the determined mechanical eigenfrequency of the component of the photonic integrated circuit; and
apply the matched electrical signal to the component of the photonic integrated circuit.

17. The system of claim 16, wherein determining a mechanical eigenfrequency of a component of the photonic integrated circuit comprises:
identifying a frequency requirement of the optical component; and
adjusting the mechanical eigenfrequency of the optical component to match the identified frequency requirement.

18. The system of claim 17, wherein adjusting the eigenfrequency of the optical component to match the identified frequency requirement comprises adjusting a geometry of the optical component.

19. The system of claim 16, wherein the optical component comprises a piezo-optomechanical cantilever, and wherein the piezo-optomechanical cantilever comprises:
a piezoelectric stack, wherein the piezoelectric stack comprises one or more materials that are collectively configured to alter a shape of the piezoelectric stack in response to the electrical signal received at the modulator;
a waveguide deposited on the piezoelectric stack, wherein the waveguide is configured to route the light received by the modulator; and
wherein the piezoelectric stack includes a first region, wherein the first region is configured to actuate when the electrical signal is received at the modulator such that a length of the waveguide is altered.

20. The system of claim 16, wherein the component is an optical phase shifter, wherein the optical phase shifter is configured to apply a phase shift to an input signal of the optical phase shifter, and wherein the phase shift is based on the matched electrical signal applied to the optical phase shifter.

21. The system of claim 20, wherein the photonic integrated circuit comprises one or more optical switches, wherein each optical switch comprises one or more optical phase shifters, and wherein each optical phase shifter of the one or more optical phase shifters is driven by an electrical signal, and wherein a frequency of the electrical signal applied to each optical phase shifter is matched to a mechanical eigenfrequency of the optical phase shifter.

22. The system of claim 21, wherein the one or more optical switches are configured to form a binary mesh tree.

23. The system of claim 21, wherein the photonic integrated circuit is configured to receive an input signal, and output the received input signal to a single output of a plurality of outputs at a given time, wherein the photonic integrated circuit is configured to output the received input signal to each output of the plurality of output in a pre-determined sequence, and wherein the pre-determined sequence is based on the frequency of the electrical signals applied to each optical switch of the one or more optical switches.

24. The system of claim 21, wherein the photonic integrated circuit is configured to receive a plurality of input signals, and output the received input signals to one or more outputs of the photonic integrated circuit in a predetermined sequence, and wherein the pre-determined sequence is based on the frequency of the electrical signals applied to each optical switch of the one or more optical switches.

25. The system of claim 24, wherein the photonic integrated circuit comprises a passive optical router.

26. The system of claim 20, wherein the photonic integrated circuit comprises a phased array, wherein the phased array comprises a plurality of outputs, and wherein each output of the plurality of outputs comprises an optical phase shifter.\

27. The system of claim 20, wherein the photonic integrated circuit comprises a Mach Zehnder interferometer, and wherein the Mach Zehnder interferometer comprises the optical phase shifter.

28. The system of claim 16, wherein the component of the photonic integrated circuit comprises a beam steering cantilever.

29. The system of claim 28, wherein the photonic integrated circuit comprises a phased array, wherein the phased array comprises a plurality of outputs, and wherein each output of the plurality of outputs comprises a beam steering cantilever.

30. The system of claim 16, wherein the component comprises an electrode, and wherein applying the matched electrical signal to the component of the photonic integrated circuit comprises applying the matched electrical signal to the electrode of the component.

31. A non-transitory computer readable storage medium storing one or more programs for operating a photonic integrated circuit the one or more programs comprising instructions, which, when executed by an electronic device with a display and a user input interface, cause the device to:
determine a mechanical eigenfrequency of a component of the photonic integrated circuit;
generate an electrical signal, wherein the electrical signal is configured drive the component of the photonic integrated circuit;
match a frequency of the electrical signal with the determined mechanical eigenfrequency of the component of the photonic integrated circuit; and
apply the matched electrical signal to the component of the photonic integrated circuit.

32. The non-transitory computer readable storage medium of claim 31, wherein determining a mechanical eigenfrequency of a component of the photonic integrated circuit comprises:
identifying a frequency requirement of the optical component; and
adjusting the mechanical eigenfrequency of the optical component to match the identified frequency requirement.

33. The non-transitory computer readable storage medium of claim 32, wherein adjusting the eigenfrequency of the optical component to match the identified frequency requirement comprises adjusting a geometry of the optical component.

34. The non-transitory computer readable storage medium of claim 31, wherein the optical component comprises a piezo-optomechanical cantilever, and wherein the piezo-optomechanical cantilever comprises:
a piezoelectric stack, wherein the piezoelectric stack comprises one or more materials that are collectively configured to alter a shape of the piezoelectric stack in response to the electrical signal received at the modulator;
a waveguide deposited on the piezoelectric stack, wherein the waveguide is configured to route the light received by the modulator; and
wherein the piezoelectric stack includes a first region, wherein the first region is configured to actuate when the electrical signal is received at the modulator such that a length of the waveguide is altered.

35. The non-transitory computer readable storage medium of claim 31, wherein the component is an optical phase shifter, wherein the optical phase shifter is configured to apply a phase shift to an input signal of the optical phase shifter, and wherein the phase shift is based on the matched electrical signal applied to the optical phase shifter.

36. The non-transitory computer readable storage medium of claim 35, wherein the photonic integrated circuit comprises one or more optical switches, wherein each optical switch comprises one or more optical phase shifters, and wherein each optical phase shifter of the one or more optical phase shifters is driven by an electrical signal, and wherein a frequency of the electrical signal applied to each optical phase shifter is matched to a mechanical eigenfrequency of the optical phase shifter.

37. The non-transitory computer readable storage medium of claim 36, wherein the one or more optical switches are configured to form a binary mesh tree.

38. The non-transitory computer readable storage medium of claim 36, wherein the photonic integrated circuit is configured to receive an input signal, and output the received input signal to a single output of a plurality of outputs at a given time, wherein the photonic integrated circuit is configured to output the received input signal to each output of the plurality of output in a pre-determined sequence, and wherein the pre-determined sequence is based on the frequency of the electrical signals applied to each optical switch of the one or more optical switches.

39. The non-transitory computer readable storage medium of claim 36, wherein the photonic integrated circuit is configured to receive a plurality of input signals, and output the received input signals to one or more outputs of the photonic integrated circuit in a predetermined sequence, and wherein the pre-determined sequence is based on the frequency of the electrical signals applied to each optical switch of the one or more optical switches.

40. The non-transitory computer readable storage medium of claim 39, wherein the photonic integrated circuit comprises a passive optical router.

41. The non-transitory computer readable storage medium of claim 35, wherein the photonic integrated circuit comprises a phased array, wherein the phased array comprises a plurality of outputs, and wherein each output of the plurality of outputs comprises an optical phase shifter.\

42. The non-transitory computer readable storage medium of claim 35, wherein the photonic integrated circuit comprises a Mach Zehnder interferometer, and wherein the Mach Zehnder interferometer comprises the optical phase shifter.

43. The non-transitory computer readable storage medium of claim 31, wherein the component of the photonic integrated circuit comprises a beam steering cantilever.

44. The non-transitory computer readable storage medium of claim 43, wherein the photonic integrated circuit comprises a phased array, wherein the phased array comprises a plurality of outputs, and wherein each output of the plurality of outputs comprises a beam steering cantilever.

45. The method of claim 31, wherein the component comprises an electrode, and wherein applying the matched electrical signal to the component of the photonic integrated circuit comprises applying the matched electrical signal to the electrode of the component.
